(19) United States
(12) Patent Application Publication
(10) Pub. No.: US 2014/0286554 A1
(43) Pub. Date: Sep. 25, 2014

(54) METHOD AND APPARATUS FOR MAGNETIC RESONANCE TOMOGRAPHY IMAGE RECONSTRUCTION

(71) Applicant: Swen Campagna, Engelthal (DE)

(72) Inventor: Swen Campagna, Engelthal (DE)

(21) Appl. No.: 14/220,449

(22) Filed: Mar. 20, 2014

(30) Foreign Application Priority Data
Mar. 20, 2013 (DE) 102013204890.4

(51) Int. Cl. G06T 1/20; G06T 11/00

(52) U.S. Cl. CPC G06T 1/20; G06T 11/003
USPC 382/131

(57) ABSTRACT

In a method and apparatus for determining an image from measurement data from a magnetic resonance tomography a first step can be executed in parallel for multiple subsets of the measurement data in multiple instances, wherein the individual instances each allocate distinct resources. A second step is executed, which allocates predetermined resources and executes a maximum predetermined number of instances from the first step, using the predetermined resources.

### BACKGROUND OF THE INVENTION

1. Field of the Invention

The invention concerns, in particular, a method that is suited for determining an image from measurement data of a magnetic resonance tomography. The method has a first step, which can be executed in parallel for multiple subsets of the measurement data, in multiple instances wherein distinct resources are allocated for the respective individual instances. An application of the method in other technical fields, in which computations likewise occur in parallel for measurement values or data determined therefrom, is likewise possible.

2. Description of the Prior Art

Modern computers have numerous processor cores (multi-core processors). In order to make use of the capabilities of these processors in an optimal manner, it is desirable to utilize these processor cores to capacity, as equally as possible, by means of processes that can run in parallel, also referred to as tasks or threads. Because methods known in the prior art are designed to be executable independently of a specific computer configuration, on different computers, with different numbers of processor cores, this number of identical processes running in parallel, also referred to as instances of a process, is typically not limited by such conventional methods.

In the ideal case, the number of processes running in parallel corresponds to the number of processor cores, such that each multi-core processor is permanently utilized to capacity with a process. However, if more processes, or instances of a process are executed than the number of available multi-core processes, then an additional processing load occurs as a result of changing the processes, and the efficiency is further diminished. Furthermore, each instance of a process makes use of further resources, such as memory stacks, or pushdown stacks. If the occupied memory exceeds the physically available memory capacity in the cache, or random access memory (RAM), then the contents must be stored in other, slower memories such as the hard drive, and the (performance) capacity of the computer diminishes with regard to the execution of the process.

Typically, individual tasks are identified in the determination of an image, which can be executed independently of one another, or simultaneously, on independent data sets, this being as a process or numerous instances of a process executed in parallel in the method. It is thus possible to design known methods such that only a specific number of procedures of the process occur at any one time, thus limiting the number of instances, as well as the resources reserved for them.

In providing methods of this type, it is also desirable to make use of so-called libraries, which provide optimized processes for certain tasks. Examples of this are the “multi-threaded MKL library” from Intel, or “OpenMP.” These libraries, however, are configured to run only on computers with an arbitrary number of processor cores, and thus do not limit the number of instances of processes in the internal execution. If these libraries are initiated at different locations in the course of the method, then an uncontrolled number of instances of processes would be generated, and a breakdown in efficiency could occur.

### SUMMARY OF THE INVENTION

An object of the present invention is to provide a method and apparatus that achieve improved efficiency with the use of any libraries.

The method and apparatus according to the invention execute a second step, in addition to the aforementioned first step, which allocates pre-determined resources, and executes a maximum pre-determined number of instances of the first step, using the pre-determined resources.

Advantageously, the method according to the invention limits and controls the number of instances of the first step and the resources reserved for this. Thus, it can also be ensured, even with the use of general libraries, from which the first step is derived, that the efficiency of the method is not impaired through unlimited use of resources.

The apparatus according to the invention shares the advantages of the method according to the invention.

In a preferred embodiment of the method according to the invention, initiations of the first step occur as a result of executing the second step.

Thus, it is possible to control the execution of the first step, without making changes to the libraries.

In one embodiment of the method according to the invention, it is also conceivable that the initiations of the first step occur only as a result of executing the second step.

In this manner, it is possible to ensure complete control over instances of the first step by execution of the method.

In another embodiment of the method according to the invention, the second step implements a registration of the initiations of the first step, and the initiations of the first step occur in the sequence of the registrations in the queue.

A queue of this type makes it possible to not have to wait for an execution of the second step, and the first step initiated thereby, for the process initiating the second step, but instead, other steps, independent thereof, can be executed.

### BRIEF DESCRIPTION OF THE DRAWINGS

FIG. 1 schematically illustrates a magnetic resonance tomography apparatus according to the invention.

FIG. 2 schematically shows an embodiment of the structure for a control unit according to the invention.

FIG. 3 is a flowchart of a method according to the prior art.

FIG. 4 is a flowchart of an embodiment of the method according to the invention.

### DESCRIPTION OF THE PREFERRED EMBODIMENTS

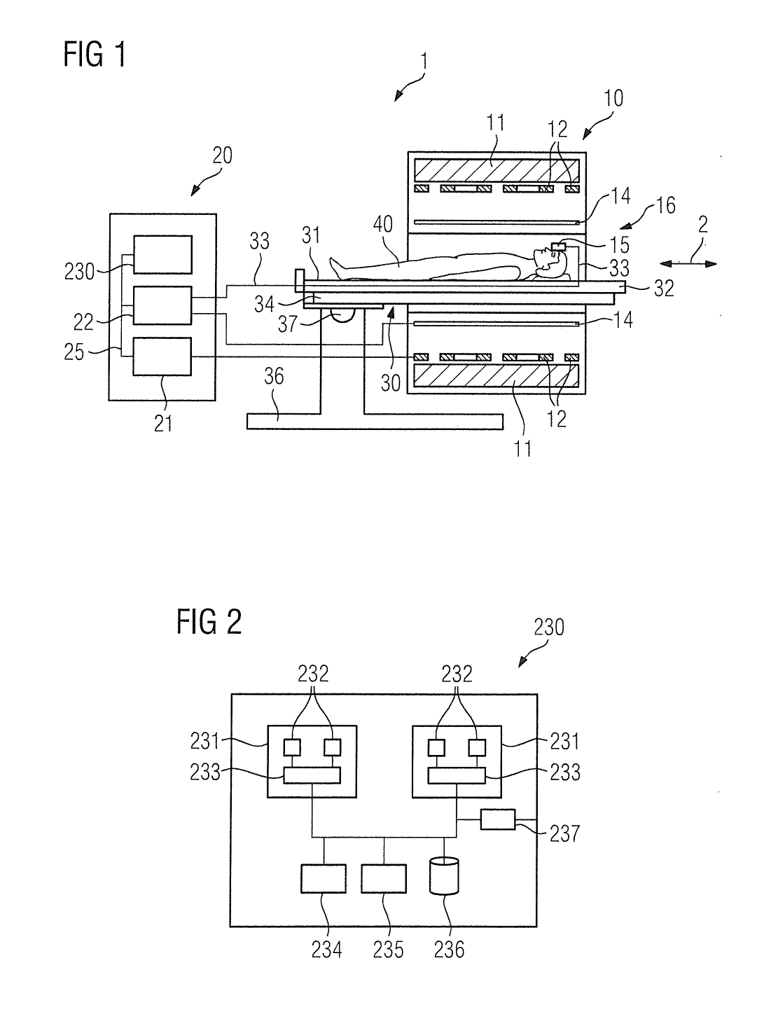

FIG. 1 schematically depicts a magnetic resonance tomography apparatus 1 according to the invention, for executing the method according to the invention.

The magnet unit 10 has a field magnet 11, which generates a magnetic field BO for the alignment of nuclear spins of samples or patients 40 in a sample volume. The sample volume is disposed in a passageway 16, which extends in a longitudinal direction 2 through the magnet unit 10. Typically, the field magnet 11 is a superconducting magnet, which can provide magnetic fields having a magnetic flow density of up to 3T, or even more with newer apparatuses. For smaller field strengths, however, permanent magnets or electromagnets having normal conducting coils can be used.

Furthermore, the magnet unit 10 has gradient coils 12, which are designed to superimpose variable magnetic fields on the magnetic field B0 in three dimensions for spatial differentiation of the recorded imaging region in the sample volume. The gradient coils 12 are typically coils made of normal conductive wires, which can generate fields in the sample volume that are orthogonal to one another.

The magnet unit 10 also has a body coil 14, which is designed for emitting a radio-frequency signal in the sample volume via a signal line, and to receive resonance signals emitted from the patient 40, and to deliver these via the signal line. Preferably, however, the body coil 14 is replaced by local coils 15 for emitting and/or receiving the radio-frequency signal, which are disposed close to the patient 40 in the passageway 16.

A control unit 20 supplies the magnet unit 10 with the various signals for the gradient coils 12 and the body coil 14, or the local coils 15, respectively, and evaluates the signals that are received.

Thus, the control unit 20 has a gradient control unit 21, which is designed to supply the gradient coils 12 with variable currents via feed cables, which supplies the desired gradient fields in the sample volume, coordinated in a temporal manner.

Furthermore, the control unit 20 has a radio-frequency unit 22, which is designed to generate a radio-frequency pulse having a pre-definable temporal course, amplitude and spectral performance distribution, for exciting nuclear spin in the patient 40 so as to emit magnetic resonance signals. Pulse powers in the kilowatt range can be obtained thereby.

The radio-frequency unit 22 is also designed to evaluate radio-frequency signals received from the body coil 14 or a local coil 15, and transmitted to the radio-frequency unit 22 via a signal line 33, in terms of their amplitude and phase. These signals are, in particular, radio-frequency signals emitted from nuclear spins in the patient 40 in response to the excitation by the radio-frequency pulse in the magnetic field B0, or in a magnetic field resulting from a superimposing of B0 and gradient fields.

Furthermore, the control unit 20 has a sequencer 230, which is designed for performing the temporal coordination of the activities of the gradient activation device 21 and the radio-frequency unit 22. For this purpose, the sequencer 230 is connected to the other units 21, 22 via a signal bus 25, and exchanges signals therewith. The sequencer 230 is designed for receiving signals from the patient 40 evaluated by the radio-frequency unit 22, and to process and/or define and coordinate, in a temporal manner, the pulse and signal shapes of the gradient activation device 21 and the RF pulse generating unit 230.

The patient 40 is disposed on a patient bed 30. Such a patient bed 30 is known from magnetic resonance tomography. The patient bed 30 has a first support 36, disposed under a first end 31 of the patient bed 30. In order for the support 36 to be able to maintain the patient bed 30 in a horizontal position, it typically has a foot, which extents along the patient bed 30. In order to move the patient bed 30, the foot can also have means, such as wheels, for facilitating this. Aside from the support 36 at the first end 31, the patient bed has no other structural elements between the floor and the patient bed, such that the patient bed can be inserted into the tunnel or bore 16 of the field magnets 11 as far as the first end 31. In FIG. 1, linear rail systems 34 are depicted, which connect the support 36 to the patient bed 30 such that it can be moved, so that the patient bed can be displaced along the longitudinal direction 2. For this purpose, the linear rail system 34 has a drive 37, which makes it possible for the patient bed 30 to be moved in the longitudinal direction 2 by an operator or the sequencer 230, in a controlled manner, such that regions of the body of the patient can be examined that extend beyond the sample volume in the tunnel 16.

FIG. 2 shows a schematic structure for a sequencer 230. The sequencer 230 has numerous processors 231, each having numerous processor cores 232. Furthermore, the processors 231 are provided with a cache 233. The sequencer 230 also has a RAM 234, a ROM 235, a bulk memory 236 and an interface module 237.

It is, however, also possible for the sequencer 230 to have only one processor 231 with numerous processor cores 232, or inversely, numerous processors 231 each having one processor core 232. Likewise it is conceivable for each processor core 232 to be allocated to a cache 233, and/or the processor cores 232 share a common cache 233.

It is also conceivable for components of the sequencer 230 to be separated or distributed. As an example, the temporal coordination of the activities of the gradient control means 21 and the radio-frequency unit 22 can be implemented as a part of the control unit 20, while the evaluation of the measurement data and the generation of an image can be executed in a separate unit, which is not an integral part of the magnetic resonance tomography apparatus 1. This could then, for example, have a signal connection to the magnetic resonance tomography apparatus 1 via an interface module 237 and a network.

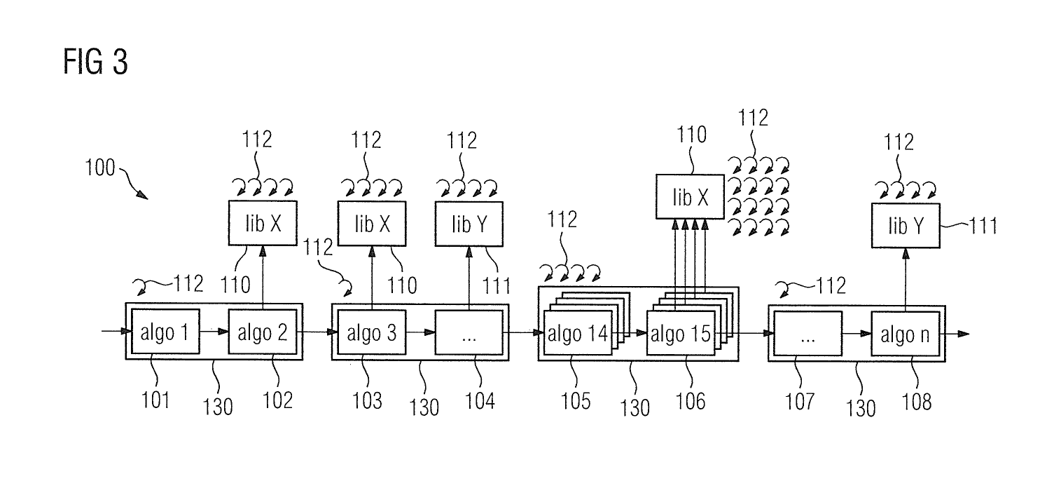

FIG. 3 depicts a sequence for a method 100 from the prior art. The method has a series of steps 101-108, which are executed successively, from left to right, during the processing of measurement data for generating an image. Some of the steps 105, 106 can be executed simultaneously on different subsections of the measurement data, and for this reason, are instanced multiple times. The initiations of steps 110, 111 are depicted above the steps 101-108. These can be part of a library, for example, such as the Intel multithreaded MKL library, or an OpenMP program generated with the language extension OpenMP. These steps 110, 111 generate, in turn, numerous instances of steps on their own. The number of thread instances 112 is indicated, in each case, by the arrow symbol having the reference symbol 112. In the depicted example, each initiation generates a step 110, 111 of a library, which in turn comprises, in each case, four thread instances 112. In doing so, numerous steps can be combined, and executed collectively in one thread, as is indicated, respectively, by the frame 130. By means of the initiation of step 110 in step 106, which itself is executed multiple times, the number of instances of step 110, being four, (number of instances of step 110 for each initiation) is multiplied by four (number of instances of step 106) for a total of 16.

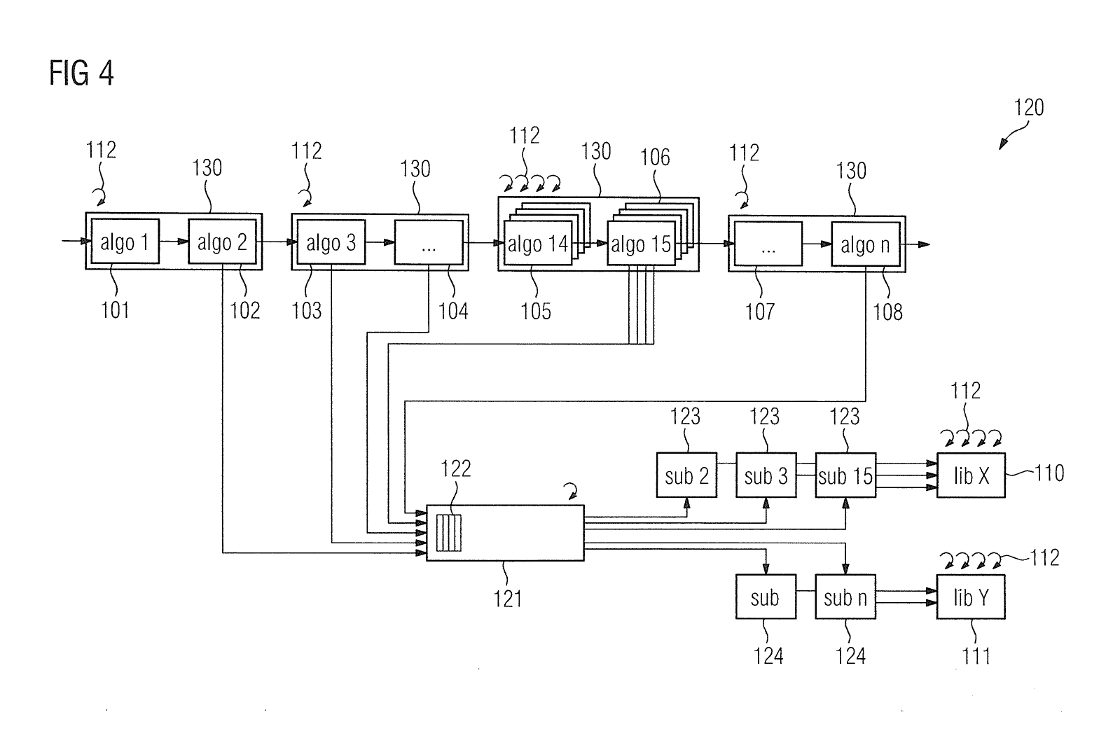

FIG. 4 depicts a sequence for a method 120 according to the invention. The method has a series of steps 101-108, which are executed successively, from left to right, during the processing of measurement data for generating an image. Some of the steps 105, 106 can be executed simultaneously on different subsections of the measurement data. As explained, it is also possible for numerous steps 105, 106 to be executed collectively in one thread, as is indicated by the frame 130. The corresponding threads are instanced multiple times in the thread instances 112 for this reason. It is possible for the method according to the invention to have further steps in addition thereto.

The method 120 according to the invention differs from the method 100 in FIG. 3, particularly by the execution of a second step 121. In the following, this will also be referred to as a separator 121, because it separates the initiating steps 102-108 from the first steps 110, 111 of the libraries X and Y. If one of these steps 102-108 initiates a first step 110, 111, it does not do so directly, but rather by means of initiating the separator 121.

The separator 121 makes use of resources allocated specifically for it; in particular, it is executed by a distinct thread, which is preferably the same one for the entire lifetime of the separator 121. In the depiction in FIG. 4, the separator 121 has its own passive sub-thread 123, 124 for each of the initiating steps 102-108. These are referred to as sub-threads 123, 124, because they only access the resources allocated for the separator 121, and are executed in its thread, for which reason they are also referred to as passive. Because the sub-threads 123, 124 are applied collectively with the separator 121, it is also conceivable to regard these as part of the separator 121. The code for the sub-threads 123, 124 is preferably first installed and executed, as needed, in the context of the thread. It is also conceivable, however, that these have the same life expectancy as that of the separator 121. It would also be possible to configure the initiation of the first step from the library by means of the separator 121 in a different manner, e.g. in that a single sub-thread 123 is used collectively for initiating from all of the steps 102-108.

In a preferred embodiment, the separator 121 has a queue 122, in which the initiations of the first steps 123, 124 by the steps 101-108 are cached in the sequence in which they are received. As soon as an instance from the first step 110 or 111 is free in the thread for the separator 121, the next initiation is executed by the respective step 102-108 in the queue. A predefined sequence thus is ensured, and the initiation steps 102-108 do not need to monitor the sequence themselves.

Fundamentally, it is also conceivable, as an embodiment of the invention, to initiate the sub-thread 123 directly from one of the steps 102-108, wherein the sub-thread, in each case, would be executed in the context of the thread for the initiating step.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for reconstructing an image from magnetic resonance . measurement data, comprising:
providing magnetic resonance measurement data from a magnetic resonance tomography apparatus to a computerized processor;
in said processor, executing an image reconstruction algorithm to reconstruct an image from said magnetic resonance measurement data;
executing a first step in said reconstruction algorithm in parallel in a plurality of instances for a plurality of subsets of said magnetic resonance measurement data, in order to allocate individual instances, among said plurality of instances, to individual resources of said computerized processor;
executing a second step in said reconstruction algorithm in which predetermined resources are allocated and in which a maximum predetermined number of said instances allocated in said first step are executed, using said predetermined resources; and
making the reconstructed image available in electronic form at an output of the processor.

2. A method as claimed in claim 1 comprising, in said processor, executing initiations of said first step that result from executing said second step.

3. A method as claimed in claim 2 comprising, in said second step, generating a queue of said initiations of said first step, and executing said initiations of said first step as a sequence according to said queue of said initiations.

4. A method as claimed in claim 1 comprising, in said processor, executing initiations of said first step that result only from executing said second step.

5. A method as claimed in claim 4 comprising, in said second step, generating a queue of said initiations of said first step, and executing said initiations of said first step as a sequence according to said queue of said initiations.

6. A magnetic resonance tomography apparatus, comprising:
a magnetic resonance data acquisition unit;
a control unit configured to operate said magnetic resonance data acquisition unit to acquire magnetic resonance measurement data;
a computerized processor provided with said magnetic resonance measurement data;
said processor being configured to execute an image reconstruction algorithm to reconstruct an image from said magnetic resonance measurement data;
said processor being configured to execute a first step in said reconstruction algorithm in parallel in a plurality of instances for a plurality of subsets of said magnetic resonance measurement data, in order to allocate individual instances, among said plurality of instances, to individual resources of said computerized processor;
said processor being configured to execute a second step in said reconstruction algorithm in which predetermined resources are allocated and in which a maximum predetermined number of said instances allocated in said first step are executed, using said predetermined resources; and
said processor being configured to make the reconstructed image available in electronic form at an output of the processor.

7. An apparatus as claimed in claim 6 wherein said processor is configured to execute initiations of said first step that result from executing said second step.

8. An apparatus as claimed in claim 7 wherein said processor is configured, in said second step, to generate a queue of said initiations of said first step, and to execute said initiations of said first step as a sequence according to said queue of said initiations.

9. An apparatus as claimed in claim 6 wherein said processor is configured to execute initiations of said first step that result only from executing said second step.

10. An apparatus as claimed in claim 9 wherein said processor is configured, in said second step, to generate a queue of said initiations of said first step, and to execute said initiations of said first step as a sequence according to said queue of said initiations.
